(19) United States
(12) Patent Application Publication
(10) Pub. No.: US 2024/0246151 A1
(43) Pub. Date: Jul. 25, 2024

(54) Methods for Additive Manufacturing of a Component

(71) Applicant: Siemens Aktiengesellschaft, München (DE)

(72) Inventors: Raven Thomas Reisch, München (DE); Tobias Hauser, Bubesheim (DE); Tobias Kamps, München (DE)

(73) Assignee: Siemens Aktiengesellschaft, München (DE)

(21) Appl. No.: 18/564,212

(22) PCT Filed: May 6, 2022
(86) PCT No.: PCT/EP2022/062247

§ 371 Date: Nov. 27, 2023

(30) Foreign Application Priority Data
May 26, 2021 (EP) 21176030.1

(51) Int. Cl. B22F 10/85; B22F 10/25; B22F 12/90; B23K 9/04; B23K 26/03; B23K 26/342; B33Y 10/00; B33Y 50/02

(52) U.S. Cl. CPC B22F 10/85; B22F 12/90; B23K 26/03; B33Y 10/00; B33Y 50/02; B22F 10/25; B22F 2203/03; B23K 9/04; B23K 26/342

(57) ABSTRACT

Various embodiments of the teachings herein include a method for additive manufacturing of a component. An example method includes: creating a machine code and transmitting the machine code to a controller; starting an additive manufacturing process to build the component using a print head; monitoring the process with sensors; evaluating sensor data to identify anomalies in the component during the manufacturing process; establishing a parallel digital twin of the component from sensor data comprising position data of the anomaly; predicting a position of the print head at a specific time using the machine code; analyzing a working area around the predicted position with respect to anomalies present using the digital twin; and adjusting process parameters of the manufacturing process when the working area is reached to eliminate the anomaly.

### CROSS-REFERENCE TO RELATED APPLICATIONS

This application is a U.S. National Stage Application of International Application No. PCT/EP2022/062247 filed May 6, 2022, which designates the United States of America, and claims priority to EP Application No. 21176030.1 filed May 26, 2021, the contents of which are hereby incorporated by reference in their entirety.

### TECHNICAL FIELD

The present disclosure relates to manufacturing. Various embodiments of the teachings herein include systems and/or methods for additive manufacturing of a component.

### BACKGROUND

Wire Arc Additive Manufacturing (WAAM) is an example of a method that makes possible the manufacturing of metallic components in large volumes. A further typical method for this is the Laser Metal Deposition (LMD) method. In such methods, the absence of repeatability of the process represents a challenge to quality assurance. In order to make sure that the component has a sufficiently high quality, the process must be monitored. In-situ monitoring systems make possible the in-situ monitoring of what is happening during the process.

If defects in the process are recognized, the knowledge gained about the defects has until now not been used in order to implement process adjustments. The reason for this is that the defect that is present and how said defect is to be rectified is not known. If an anomaly is detected the process must therefore be aborted right away and the component is scrap.

### SUMMARY

The teachings of the present disclosure include systems and/or methods for additive manufacturing of a component that, when compared to the prior art, have an improved process control and reduces the scrappage rate during production. For example, some embodiments include a method for additive manufacturing of a component comprising: creating a machine code; transmitting the machine code to a controller; starting the manufacturing process; monitoring the process with sensors; assessing the sensor data for determining an anomaly in the component to be manufactured, and also; establishing a digital twin of the resulting component from the sensor data comprising position data of the anomaly; prediction of the position 12 of a print head 14 at a specific time by means of the machine code; analysis of a working area around this position in respect of anomalies present by means of the digital twin; and adjustment of the process parameters on reaching the working area, for eliminating the anomaly.

In some embodiments, a model is used for evaluating the sensor data, through which, in a dynamic period of time, feedback data to the controller (4) is computed.

In some embodiments, the dynamic period of time amounts to between 0.05 s and 3 s.

In some embodiments, a time stamp is assigned to each position (12) to which the print head (14) moves.

In some embodiments, the digital twin (10) comprises a point cloud (16) and for each point an anomaly value is determined for which a process state is stored.

In some embodiments, to determine the anomaly value, data of a working area (18) from neighboring points (17, 17′) is also included.

In some embodiments, the working area (18) has the spatial dimension of a liquid phase (20) obtaining at the point of observation.

In some embodiments, the point cloud is shown in a spatially structured data structure in the form of an octree.

In some embodiments, the working area (18) is shown by a double ellipsoid (22).

In some embodiments, the axes of the ellipsoid are adjusted to the dimension of the weld pool.

In some embodiments, the adjustment of the process parameters for eliminating the anomaly (8) comprises a greater application of heat.

In some embodiments, the adjustment of the process parameters for eliminating the anomaly (8) comprises a lower print head speed.

In some embodiments, the additive method of manufacturing is an arc wire cladding method.

In some embodiments, the additive method of manufacturing is a Laser Metal Deposition (LMD) method.

### BRIEF DESCRIPTION OF THE DRAWINGS

Further embodiments of the teachings herein and further features will be described in greater detail with the aid of the figures below. In the figures:

FIG. 1 is a schematic diagram showing an example system for wire arc additive manufacturing incorporating teachings of the present disclosure;

FIG. 2 is an illustration showing an example point cloud of a digital twin of a component produced incorporating teachings of the present disclosure; and

FIG. 3 is a diagram showing a working area in the form of double ellipsoid for determination of anomalies incorporating teachings of the present disclosure.

### DETAILED DESCRIPTION

In this disclosure, some of the terms used are defined as follows:

“Print head” refers to the component of an additive manufacturing apparatus that is responsible for applying the material. In WAAM, this is the element at which the end of the wire to be welded on is guide. In the LMD method, this is the element at which the laser beam for melting the powder emerges. The print head during the process is a defined feature, for example the tip of an electrode or a wire exit opening, at a specific position.

This position of the print head in its turn correlates spatially equidistantly with a working point in or on the surface of the resulting component. A distinction is therefore made between the position of the print head and the working point at the component, since these do not coincide spatially in different additive manufacturing methods but are always related to one another in a positively controlled fashion.

A “sensor”, also referred as a detector, (measured value or measurement) transducer or (measurement) probe, is a technical component that can detect specific physical or chemical characteristics (physically for example amount of heat, temperature, moisture, pressure, sound field variables, brightness, acceleration or chemically, for example pH value, ion strength, electrochemical potential) and/or which can detect the material composition of its environment qualitatively or as a measured value quantitatively. These variables are detected by means of physical, chemical, or biological effects and are transformed into a further processed, especially electrical, signal, the sensor signal.

An “electrical signal” is a specific form of a physical signal. It involves an electrical variable such as dielectric strength, voltage or resistance, when it is in any way variable and can thus accept and transport information. Equivalent value, peak value, frequency, phase offset angle or degree of sampling come into consideration for example as value of the signal. Mathematical evaluations, i.e. a further processing of physical sensor data, are also referred to as sensor data as such.

A “digital twin” is a digital representation of a material or immaterial object or process from the real world in the digital world. Digital twins make an all-encompassing exchange of data possible. In such cases they are more than pure data and consist of models of the object or process represented and as well as these, can contain simulations, algorithms and services, which describe, influence or provide services about the characteristics or behaviors of the object or process represented.

A “controller” is a processing unit that is capable of executing models and processing the data. Example of controls are NC (Numerical Control, such as Sinumerik), Edge Devices (Industrial Edge or Sinumerik Edge (a computer that connects networks and can evaluate data)), an IPC (Industrial PC without connection to the second network) or PLC (Programmable Logic Controller, such as for example Simatic S7).

“Position data” is a dataset that, starting from a coordinate system defined before the beginning of the process, defines a location in the process environment in relation to said system.

“Process parameters” are parameters with which a desired process behavior can be set. For Wire Arc Additive Manufacturing for example these include gas flow, current, voltage, weld advance, wire advance, distance of the welding torch from the component and inclination of the welding torch. Further, for LMD (Laser Metal Deposition), the laser power, powder feed and laser focus also count as typical process parameters.

The teachings of the present disclosure, when compared to the prior art, take account of the process strongly depending on its current environment. If for example oxidation occurs in layer three, then this likewise leads in the following layer to an abnormal process behavior. The same is true for neighboring weld beads. Despite this, in process analysis according to the prior art, the current data point is used, but no information of earlier data points of the same print is integrated into the data evaluation.

In the teachings of the present disclosure, at the respective point in time, these are not ignored, but are incorporated into the simulation and implementation of compensation measures. In this way, an oxidation or a shape deviation also has effects on the following layers and on the data collected here. Effects of defects over a number of layers are now sufficiently taken into account, so that defects over a number of layers are correlated with one another. Thus information that already exists is utilized to obtain better results in the data analysis within the framework of the in-situ monitoring and is not lost. Temporal and spatial context, to which great importance is attributed in the additive manufacturing process, is used to advantage by the inventive solution in the data evaluation, and defect rectification methods can be initiated in situ.

In some embodiments, a model is used to evaluate the sensor data, through which, in a dynamic period of time feedback data is computed at the controller. For integration of a temporal context, (as a rule neural network) models are used, which evaluate the current data point with respect to an anomaly value on the basis of past values. The period of time that is used as the temporal context changes in this case dynamically depending on how high for example the current welding speed or how long the weld pool is (able to be detected via weld camera+computer vision algorithms such as for example Canny Edge Detection). A typical dynamic duration amounts in this case for example to 0.5 s, wherein the time interval preferably moves in a period of time of between 0.05 s and 3 s, especially preferably between 0.1 s and 1 s.

In some embodiments, each location that the print head moves to is allocated a time stamp, so that information can be evaluated retroactively with respect to the prevailing process situation at the given point in time. To this extent it is also expedient for the digital twin to be designed in the form of a point cloud and for an evaluation of the process state to be stored for each point of the cloud. Evaluation criteria are for example the type of the anomaly (for example oxidation or pores). An anomaly is thus a preliminary stage of a defect, it can also be referred to as a potential defect.

In some embodiments, an anomaly value is determined for each point, for the computation of which in its turn, information i.e. process data and sensor data from neighboring points within a working area, are also included. In this case, the spatial extent of a liquid phase obtaining at the time of the observation is preferably included as the working area. The form of a double ellipsoid, which is well able to be detected mathematically in the evaluation, has proved to be advantageous for the definition of the working area and for its virtual transmission into the digital twin. In some embodiments, the working area is changed continuously with the form and the size of the liquid phase, i.e. of a local weld pool. Form and size of the liquid phase can be detected for example by means of a weld camera or be derived from the component temperature and the current energy input. A special form of the double ellipsoid is the ellipsoid that is symmetrical with regard to half its longitudinal axis. The sphere is a special form of ellipsoid.

In some embodiments, the adjustment of the process parameters for rectification of the anomaly are implemented at the point of or in the vicinity of the anomaly, in order for example to burn off an oxidation by means of a locally increased amount of heat and/or to slow down the speed of movement of the print head in order to melt a porous structure and thus to rectify it.

The decision about whether, at which point in time and at which location process parameters are to be adjusted is based in this case on a prediction as to where the print head will have been moved to within a defined period of time in accordance with the machine code. The environment of the position computed in this way is subsequently searched for anomalies (for example interrogation of the octree by means of double ellipsoids). When anomalies are present in the area around this position, counter measures (for example increase in the heat applied, in the speed of movement) are initiated.

Wire Arc Additive Manufacturing (WAAD)) and Laser Metal Deposition (LMD) are especially suitable as additive manufacturing methods, in which the method described can be used to advantage.

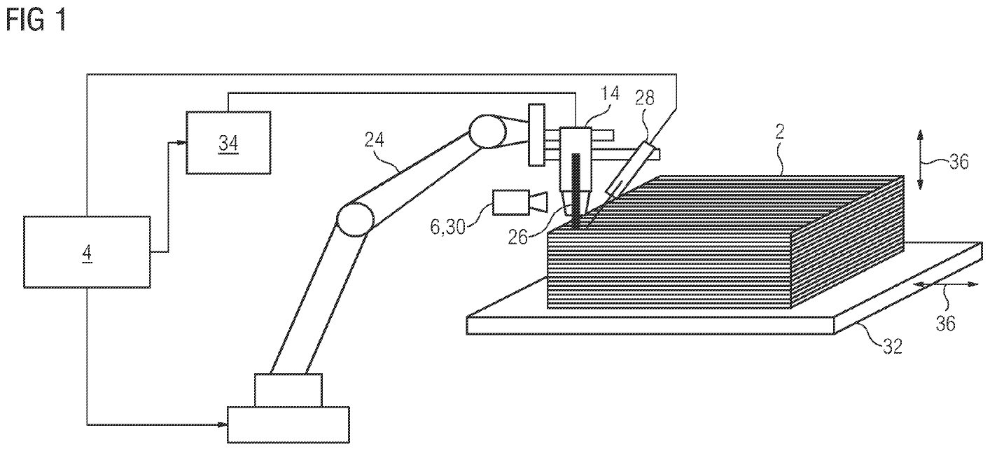

FIG. 1 is a schematic diagram showing an example additive method of manufacturing for the manufacturing of a component 2 incorporating teachings of the present disclosure. This additive method of manufacturing is embodied by way of example as Wire Arc Additive Manufacturing (WAAM). In a similar way, what is described below could also be applied to another additive method of manufacturing, such as for example Laser Metal Deposition. Here, via a robot arm 24, a print head 14 with an electrode 26 is directed to a specific position of a component 2. A welding wire 28 is further provided, which is melted by the electrode 26 at a corresponding position 12 of the print head 14. A controller 4 is further provided as well as a power supply 34, via which both the electrode 26 and also a feed of the welding wire and of the robot arm are supplied with power. The entire process is controlled via the controller 4, which will be discussed in more detail below. The process is in particular monitored by a plurality of sensors. Purely by way of example a sensor 6 in the diagram in FIG. 1 is shown in the form of a welding camera 30.

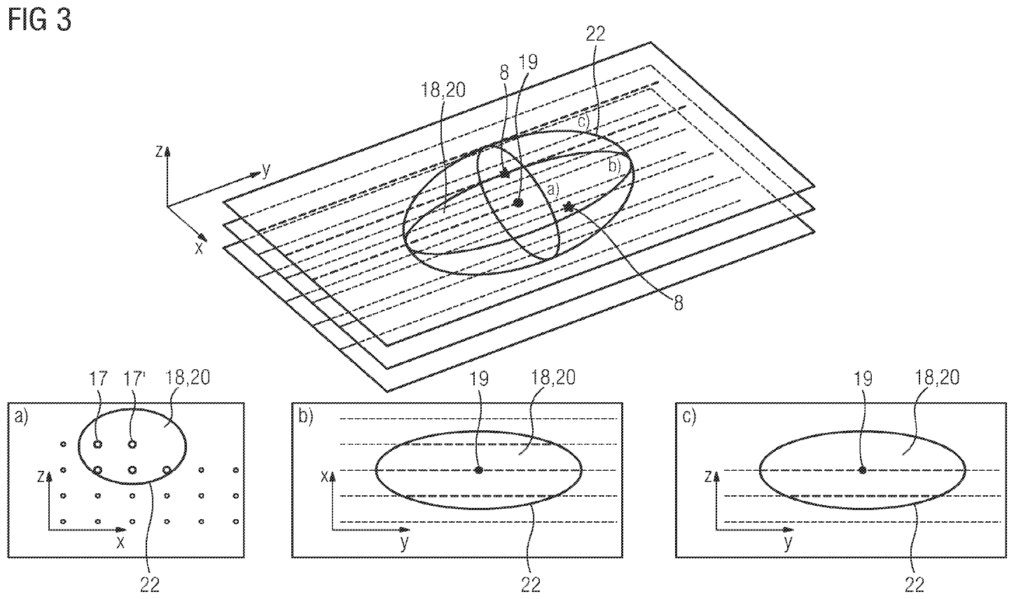

The welding camera 30 for example enables values such as the geometry of a liquid phase 20, which will be further discussed in FIG. 3, to be determined. Further sensor data are for example the voltage and the current flow in the process, the temperature of the liquid phase 20, the advance of the print head 14 and also the speed of advance of the welding wire.

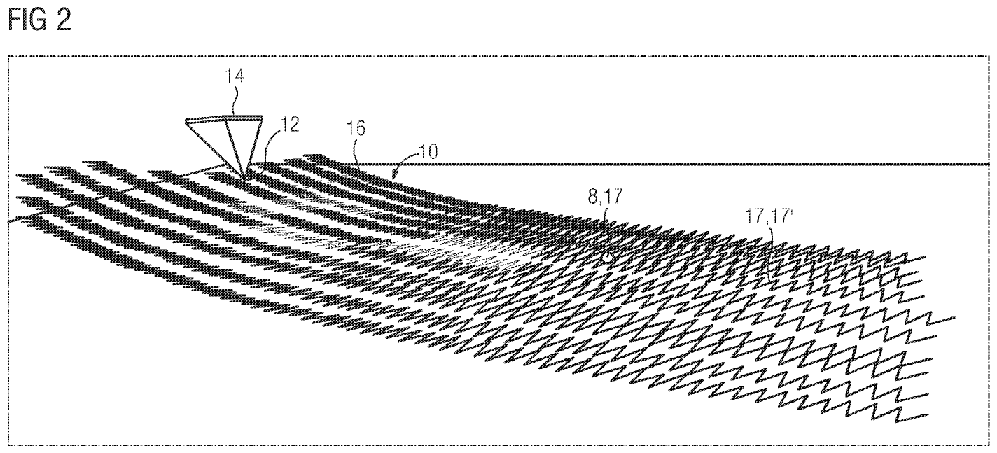

For each position 12 of the print head 14, which correlates by being able to be uniquely assigned with a position in the component 2, both the position data in the form of a point in a coordinate system and also a time stamp are recorded and passed on to the controller 4. In the controller 4 or at a computer connected to it, a digital twin 10 is simultaneously created during the printing of the component 2, which is illustrated schematically in FIG. 2. In this case the digital twin 10 comprises a point cloud 16 in which the print head 14 or its position 12 is likewise shown schematically by a triangle apex. Here an anomaly value is computed for each point 17 of the point cloud 10 determined from the sensor data and transmitted to the controller.

For evaluating the anomaly value, which will be discussed in more detail below, first of all a working area 18 on the component 2 is defined, which is shown in the digital twin by an ellipsoid, which essentially comprises a liquid phase 20 in the real component 2, in which the material of the welding wire has just melted on a surface of the component 2. A double ellipsoid has in particular proved to be expedient for the observation of liquid phases. The working area becomes especially relevant when a correlation of detected anomalies is to take place, the anomaly density is to be determined or compensation strategies are to be implemented.

In this liquid phase 20 anomalies 8 can arise when the welding wire 28 is applied, which can be preliminary stages of defects. Defects can for example be oxidation, which arises when impurities are present on the welding wire 28 or are introduced in the process. Also air inclusions in the form of pores can be anomalies and become defects. In the evaluation of anomalies in this case not only the respective point 17 observed is evaluated but there is also recourse to neighboring points 17′ in this case, which are present in the working areas 18 transmitted to the digital twin 10 in the ellipsoid 22. This is shown in the cross sectional diagrams of FIGS. 3, 3a, 3b, and 3c. For each point 17 or 17′ an anomaly value is computed, and this is then taken into account when the print head 14 once again comes close to the anomaly 8 determined in this way. The print head 14 can in this case touch the anomaly 8 from a number of sides, so that, by changing the process parameters in the vicinity of the anomaly 8 this can be compensated for, so that a defect possibly arising from the anomaly can already be eliminated before it arises. The advantage compared with conventional additive manufacturing methods lies in the fact that defects arising can already be counteracted by the process described and thus the scrappage of components 2 can be markedly reduced.

The methods described with regard to FIGS. 1-3 are further explained below in greater detail with other aspects. For integration of the temporal context (neural network) models are used, which on the basis of past values (of the last 0.5 seconds for example) assess the current (data) point 17 with respect to an anomaly value. The period of time that is used as the temporal context changes dynamically in this case as a function of how high the current welding speed (i.e. the speed of advance of the print head 14) is and how long the weld pool is. The length of the weld pool is able to be detected via the welding camera 30 in conjunction with a computer vision algorithm evaluation such as for example Canny Edge Detection. It is thereby always ensured that all process values that are relevant for the current liquid weld pool are included in the computation of the anomaly value.

For analysis of the data either regression models (prediction) can be used, such has for example Seasonal ARIMA models or neuronal networks based on Conv1D or RNN/LSTM elements, or models for reconstruction of the data with the aid of autoencoders. For prediction of the data, as well as the RNN/LSTMs with a temporal memory, CNN batch processing structures can also be used.

Temporal structures in the data, such as for example frequency changes or irregular patterns, are included in this way in the process analysis. For training, process data with constant process parameters must be used in order to achieve a high level of accuracy.

In some embodiments, each location (position 12 of the print head 14) to which the print head 14 is moved is given a time stamp which gives information about when this was moved to. The spatial context contains information about information relevant to several locations, for example from the previous layer or from adjoining welding tracks. To this end, as described, a digital image, i.e. the digital twin 10 of the component 2 is created simultaneously during the manufacturing process, by all relevant information being stored. This digital twin 10 comprises a point cloud, in which for each point an evaluation of the process state (for example normal/abnormal, anomaly value, type of anomaly, . . . ) and also a time stamp are stored. The point cloud can be stored in this case spatially structured, so that a more efficient query for spatial structures such as for example a double ellipsoid or a sphere becomes possible. Such a data structure is the octree, the r tree or the kd tree for example, which, via their tree-like structure, make possible a rapid search for points in space.

For integration of the spatial context into the computation of the anomaly value of a current working point 19 (which has a spatially equidistant connection to the print head), the space around the current working point 19 is included in the data analysis. To this end, first of all a three-dimensional working area 18 around the working point 19 is defined, via which the spatial relevance of the data points 17, 17′ is determined. This working area 18 in this case comprises the area that is occupied by the weld pool, i.e. that is occupied during the additive manufacturing liquid phase 20. As a simplification here a sphere or further generalized an ellipsoid or even further generalized a double ellipsoid in accordance with FIG. 3 can be used.

In this case the length of the ellipsoid axes can be adjusted adaptively to the geometry of the weld pool. An alignment here can take place here dynamically either on the basis of sensor data such as for example from the welding camera 30 (extract geometry of the weld pool), with the aid of process parameters such as for example the process speed (a higher welding speed leads to a thinner, longer ellipsoid) or on the basis of a thermal simulation previously carried out (temperature curve, size and shape of the weld pool). Furthermore the time stamp of the points 17 contained or simulation results can be included, in order to draw a conclusion about the cooling behavior present and thus about the size of the weld pool.

Based on the defined working area 18, points 17 that were set up in the process history are selected and are supplemented with meta information such as for example an anomaly probability value, a value for the defect criticality or a defect type. For this data structures, such as for example an octree, are used, which allow spatial indexing and thus an optimized spatial search for the points involved. Each point in this case contains information about local process anomalies or defects, so that a spatially selected point cloud with relevant information in the immediate vicinity of the current working point 19 is produced. The information contained is now used in order on the one hand to improve the anomaly recognition and on the other hand to make adjustments to the process.

The result of the anomaly evaluation by the models (incl. temporal context) is an anomaly value, which makes a statement about the probability of an anomaly and thus of the defect. At this point the spatial context is now included in two different ways: When an anomaly has been recognized, said anomaly can be linked semantically via the spatial context information to other anomalies. This makes the spatial propagation of the anomaly and thus of the potential defect visible. In this case the aforementioned double ellipsoid maps the relevant space in which defects are correlated with one another. If for example an oxidation arises in the first layer, in the following layer a problem with the bonding will be created. These two defects are related to one another so that now the spatial propagation of the abnormal area in the component can be better estimated.

When for example, in a highly stressed area of a component, there are a number of potential anomalies each with a low anomaly value, which each per se would not lead to scrappage, but which together lead to a failure of the component, the anomaly density can be determined as well, in order to estimate in this way whether a critical accumulation of anomalies is reached in one area of the component. In this case the context space for the anomaly density does not necessarily only include the space of the weld pool (liquid phase 20), but, depending on the component 2, can also be larger (for example in the area of thin webs, which as a result of anomalies could otherwise become unwanted predetermined breaking points). In this way an anomaly density in the component 2 can be determined in-situ. If this exceeds a limit value, the process can be stopped prematurely and in this way costs on account of scrappage can be reduced.

With the aid of the temporal and spatial context, over and above this, a classification of the defects can be undertaken. To do this a neural network is used for classification, which accepts as input variables pre-processed process values (with predictive models the distance between predicted and real value or with models for reconstruction the reconstruction error). In a last layer a sigmoid function is used to allocate to each defect a probability value. When it is known for example that the previous layer is already clearly cooled, since the difference between the time stamps is high, it can be concluded that there is highly likely to be an adhesion defect. Furthermore, for an oxidation in a neighboring layer for example, there is a higher probability of a defect on account of dirt inclusions.

### LIST OF REFERENCE CHARACTERS

2 Component
4 Controller
6 Sensors
8 Anomaly
10 Digital twin
12 Print head position
14 Print head
16 Point cloud
17, 17′ Points
18 Working area
19 Working point
20 Liquid phase
22 Ellipsoid
24 Robot arm
26 Electrode
28 Welding wire
30 Welding camera
32 Worktable
34 Power supply
36 Forward movement direction of worktable

What is claimed is:

1. A method for additive manufacturing of a component, the method comprising:
creating a machine code and transmitting the machine code to a controller;
starting an additive manufacturing process to build the component using a print head;
monitoring the process with sensors;
evaluating sensor data to identify anomalies in the component during the manufacturing process;
establishing a parallel digital twin of the component from sensor data comprising position data of the anomaly;
predicting a position of the print head at a specific time using the machine code;
analyzing a working area around the predicted position with respect to anomalies present using the digital twin; and
adjusting process parameters of the manufacturing process when the working area is reached to eliminate the anomaly.

2. The method as claimed in claim 1, further comprising using a model to evaluate the sensor data and, in a dynamic period of time, computing feedback data to the controller.

3. The method as claimed in claim 2, wherein the dynamic period of time amounts to between 0.05 s and 3 s.

4. The method as claimed in claim 1, further comprising assigning a time stamp to each position to which the print head moves.

5. The method as claimed in claim 1, wherein:
the digital twin comprises a point cloud; and
for each point an anomaly value is determined and a process state is stored.

6. The method as claimed in claim 5, wherein determining the anomaly value includes data of a working area from neighboring points.

7. The method as claimed in claim 6, wherein the working area has a spatial dimension of a liquid phase at the point of observation.

8. The method as claimed in claim 5, wherein the point cloud comprises a spatially structured data structure in the form of an octree.

9. The method as claimed in claim 7, wherein the working area comprises a double ellipsoid.

10. The method as claimed in claim 9, further comprising adjusting axes of the ellipsoid to a dimension of the weld pool.

11. The method as claimed in claim 1, wherein adjusting the process parameters comprises increasing an application of heat.

12. The method as claimed in claim 1, wherein adjusting the process parameters comprises reducing a print head speed.

13. The method as claimed in claim 1, wherein the additive method of manufacturing comprises an arc wire cladding method.

14. The method as claimed in claim 1, wherein the additive method of manufacturing comprises a Laser Metal Deposition (LMD) method.
